(19) United States
(12) Patent Application Publication
(10) Pub. No.: US 2006/0144236 A1
(43) Pub. Date: Jul. 6, 2006

(54) Electrostatic filtering and particle conversion in gaseous environments

(76) Inventor: Ghislain Le Boucq De Beaudignies, Fontaine-Raoul (FR)

Correspondence Address: PERMAN & GREEN, 425 POST ROAD, FAIRFIELD, CT, 06824, US

(21) Appl. No.: 10/519,648

(22) PCT Filed: Jun. 24, 2003
(86) PCT No.: PCT/FR03/09132

§ 371 Date: Jan. 11, 2006

(30) Foreign Application Priority Data
Jun. 26, 2002 (FR) 02/07970

(51) Int. Cl. B03C 3/74

(52) U.S. Cl. 96/30

(57) ABSTRACT

The invention concerns a device including at least a plurality of ionizing corona-effect electrostatic precipitators including emissive and collecting electrodes. The number of electrostatic precipitators is defined on the basis of a flux to be treated, considering that the slower the passage, the more efficient the collection is, and the less the electrodes converted into resistors are cooled by the flux. The collecting electrodes, which are smooth and tubular, are alternately collectors and electric resistor, and therefor they are heated over short periods, at a temperature sufficient for incinerating or burning the collected particles. The emissive electrodes are centered in the collecting structures. The electrodes are axial relative to the direction of the passage of the flux to be treated in the collecting electrodes and can be complementary to other electrodes in the form of beams perpendicular to the direction of the flux, gases and mists to be treated. Other devices can be associated therewith, such as oxidation catalysts, pre-filters, after filters or other devices enabling reduction of gaseous, solid and liquid pollutants and noise attenuation. The inventive device is designed, but not exclusively, for filtering and regenerating engine exhaust gases, oil and water mists, fumes, intake air, extraction or recycling, and generally all pollutants harmful to the environment.

The present invention relates to a filtering and regeneration device for particles in a gaseous environment.

Some non-exclusive applications of the device are:

filtering the exhaust gases of heat engines, among others those of trucks, tractors, buses, coaches, motor cycles, locomotives, boats, electrical generators, airplanes and all building-site engines,

filtering air, gases and mists to protect against their admission or extraction, but also to protect the environment.

Many devices and procedures already exist for treating exhaust gases and filtering the air, gases and mists. Oxidation catalysts, systems that require passage through a material to trap the particles and electrostatic precipitators that retain the particles in or on the collecting electrode all have drawbacks such as increases in loss of head or counter-pressure, need for frequent, costly maintenance, consumables that need replacing, regeneration additives that must be used at low temperature, low efficiency due to the considerable speed of passage of the flux to be treated and which drops as clogging and regeneration take place, considerable bulk of the equipment and many other drawbacks.

The device of the invention overcomes these drawbacks.

It comprises at least a plurality of ionizing corona-effect electrostatic precipitators comprising:

an outer envelope dimensioned to match the flux to be treated and comprising at least one inlet and one outlet of the same flux,

at least one support for the collecting electrodes made of one or more heat insulated dielectric plates,

at least one support for the emissive electrodes,

a plurality of collecting electrodes of sufficient number so that the flux speed to be treated is sufficiently low to obtain optimal efficiency and of tubular shape open at both ends characterized in that they are alternately collectors and electrical resistors heated to a temperature high enough to burn the particles collected,

one longitudinal emissive electrode in the center of each collecting electrode.

The features of the device ensure that:

the flux to be treated does not pass through any material and therefore neither creates nor increases loss of head,

the passage of flux through the electrodes is slow and virtually unidirectional and therefore retains a high degree of efficiency,

the collecting electrodes regenerate the trapped particles without any need for any additives or significant input of electrical power due to the considerable slowness of the flux being treated,

no consumables are required,

the device is easy to produce and does not use expensive technology,

the particle collection efficiency is not affected by the temperature of the flux being treated,

the device is compact,

thereby providing solutions to the problems inherent in the devices and procedures hitherto available.

The device of the invention makes it possible to reduce the speed of the flux of air, gas and/or mist to be treated, thereby increasing the efficiency of the electrostatic precipitators and ionization. Moreover the sequential temperature rise of the collecting electrodes incinerates the trapped particles in a zone where the speed of the flux being treated is low and therefore not greatly liable to deteriorate on energy consumption for this operation which can advantageously be automated.

The efficiency of the device can be increased by advantageously including a second or more regenerating electrostatic precipitators similar to the first and positioned after it.

Advantageously the emissive electrodes may be provided with beams perpendicular to the direction of the flux to be treated and centered on the electrodes to increase the repulsion of the particles towards the collecting electrodes.

In order to increase the oxidation of any polluting gases the device preferably includes an oxidation catalyst before or after the filter. If it is placed downstream of the electrostatic precipitators this prevents obstruction of the oxidation catalyst by particles upstream of it.

Advantageously the device includes a pre-filter and/or mechanical fine filter capable of using the Brown or shock effects, eliminator plates, mist eliminators, cyclones or any other system designed to improve the air, gases or the mists to be treated.

Preferably each component of the device can be removed.

In order to access, change or dean the components comprising the device, one or more doors or hatches that are leaktight to the flux to be treated are provided.

The particle filtering and regeneration device preferably includes a sound attenuator or silencer, particularly when it is used on heat engines.

Fastening points are provided to meet specific requirements concerning the installation of the device.

In certain cases, particularly when filtering oily air and/or mist, the device comprises suction means preferably installed downstream of the device.

As an introduction to the description of the figures, the reader is reminded that the factors influencing the efficiency of the device's electrostatic precipitators are as follows:

the speed of the flux to be treated which must be as low as possible (Deutsch's ratio),

high ionization voltage so that the charge on the particles is as high as possible; this increases the speed of their migration towards the collecting electrode,

the diameter of the collecting electrodes must be low so that the particles furthest from the central emissive electrodes are as close as possible to it.

The attached drawings illustrate the invention:

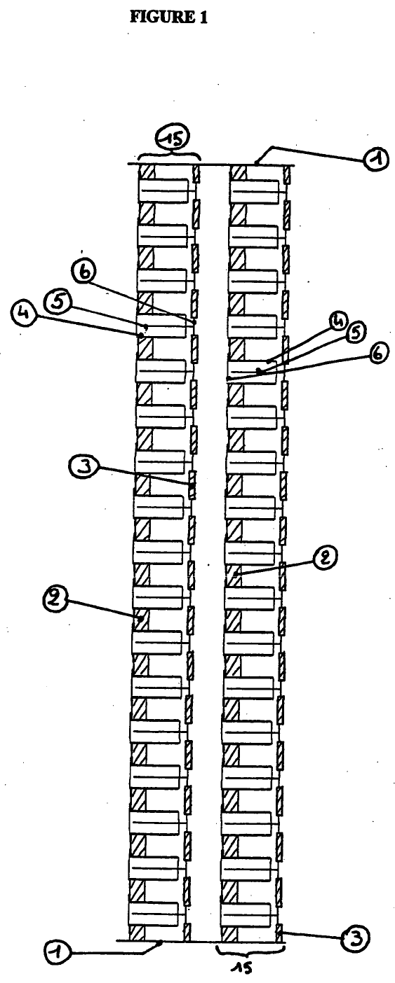

FIG. 1 is a cross-section of the device of the invention,

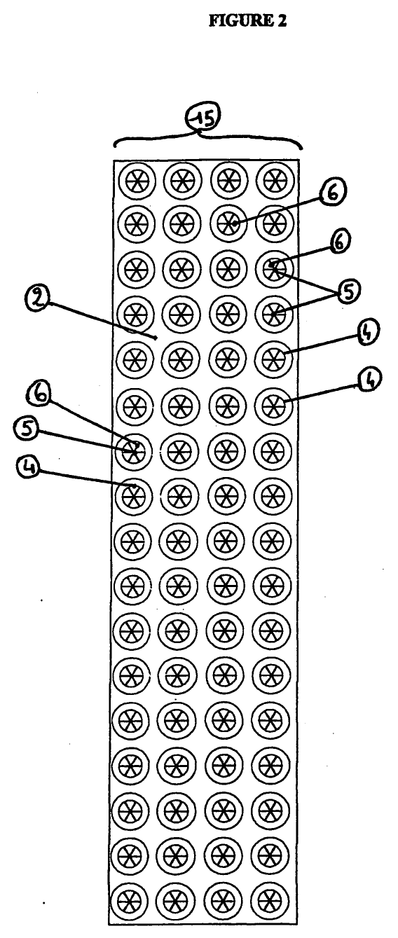

FIG. 2 shows a front view of the electrostatic precipitator seen from the side by which the flux to be treated enters,

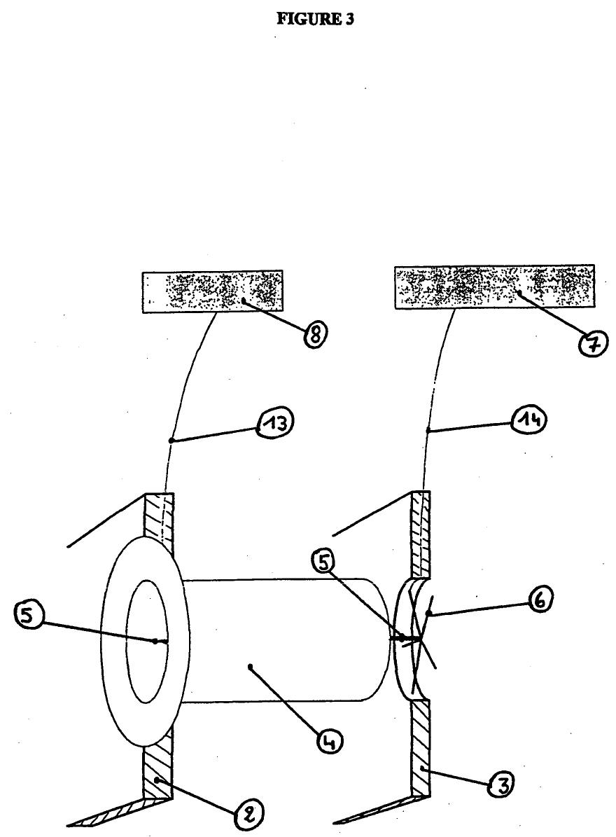

FIG. 3 is a detailed view of one component of the electrostatic precipitator,

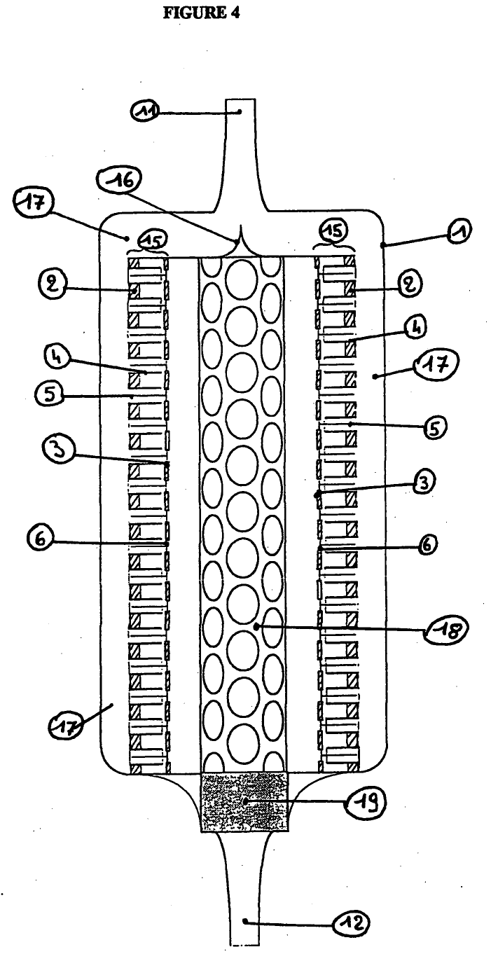

FIG. 4 shows the device of the invention, the upper section of which is open, in a preferred embodiment for use on an internal combustion heat engine,

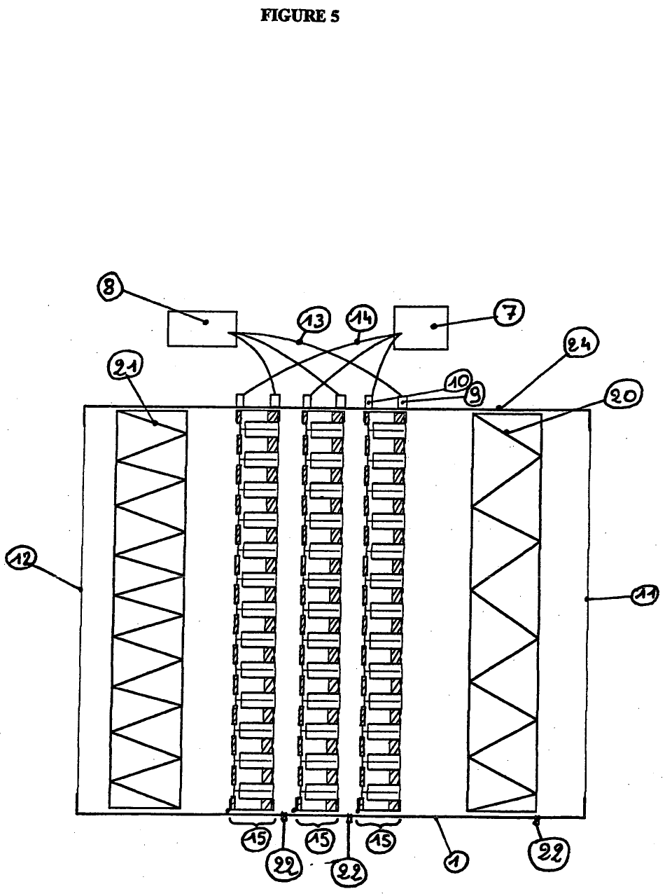

FIG. 5 shows a cross-section of the device of the invention in a preferred embodiment for use in filtering air or mist in general ventilation,

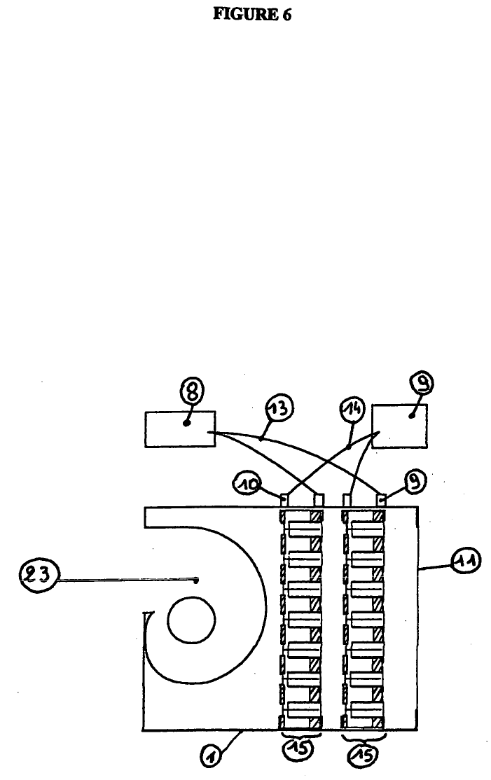

FIG. 6 shows a cross-section of the device of the invention in a preferred embodiment for use in replacing the types of air filter known as “fine”, “T.H.E.” or “absolute”.

Referring to these drawings, the device comprises a housing or envelope (1) that is open in at least two places to allow the inlet (11) of gases, air and/or mists to be treated and their outlet (12) once treated.

Inside the housing are fastened the electrostatic precipitators comprising a support (2) for the collecting electrodes which are preferable insulated thermally and dielectrically. This support comprises a plurality of collecting electrodes (4), also known as anodes, which are metallic and tubular of a diameter as small as possible (we advise a diameter of between 15 and 35 mm) and a length that we recommend should not exceed three times its diameter. These electrodes are connected (13) to ground (− on batteries providing DC supply) or earthed in installations operating on AC supply. The said electrodes are also connected by the same or other wiring to a power supply (8) capable of heating one or more collecting electrodes to 600° C. in a matter of a few seconds with a view to burning the particles collected on the electrodes. This operation takes place on all the collecting electrodes in succession and is periodically renewed either continuously, as controlled by a timer or through the intervention of a human operator.

These electrostatic precipitators also comprise a support (3) for the emissive electrodes which is preferably dielectrically insulated. This support, which is preferably positioned behind the collecting electrode support, bears the metallic emissive electrodes (5) so that they are in the center of the tubes formed by the collecting electrodes. The ends of these electrodes on the side where the flux to be treated enters are preferably pointed. Beams (6) are advantageously fastened to the said emissive electrodes to collect particles that have escaped from the influence of the tubular zone. These emissive electrodes are connected by wiring (14) that supplies the voltage necessary for correct operation of the filter. This voltage is preferably produced (7) by a transformer or converter providing a stabilized high voltage of between 1 and 30 kV, preferably of negative polarity, that is adjustable and of the highest possible amperage.

Individual connections are provided to assemble the wiring of the collecting/regenerating electrodes (9) and the emissive electrodes (10).

To increase the efficiency of the procedure, one or more assemblies (15) may be installed as described above behind the first electrostatic precipitator assembly (FIG. 1).

At the inlet of the flux to be treated, a deflector (16) advantageously directs the flux towards chambers (17) designed to give the same speed in each tubular electrostatic precipitator. This speed should not exceed 3 meters per second as it passes through the electrostatic precipitator and should preferably be below 2.5 meters per second.

Advantageously, a sound attenuator or silencer (18) is placed behind the electrostatic precipitators, particularly when the filter is used to replace the silencer of a heat engine. This application may also include a gas oxidation catalyst (19) or any other procedure designed to reduce pollutants. This component is preferably positioned after the electrostatic precipitators.

Advantageously, an inertial air pre-filter (20) that uses the Brown or shock effects, eliminator plates, mist eliminators*, cyclones or any other system designed to improve the air, gases or the mists to be treated is installed. A fine filter (21) is provided to increase and ensure the efficiency of the system.
* i.e. filter that separates out the drops and droplets in a gaseous environment.

An extraction system or a system for admitting the flux to be treated such as a ventilator (23) or other may be attached to the present invention.

A system for draining (22) the materials collected or incinerated such as oils, water, ash or other may be added to the device.

All the components enclosed by the housing or envelope forming the cover may advantageously be placed on runners (23), guides or any other systems to allow their easy, rapid, leaktight extraction.

One or more access or inspection doors or hatches (24) are provided to allow, among other things, for the cleaning of the components comprising the present invention where access for the cleaning of a particular component so requires.

1. Device for filtering and regeneration of particles in the air, gases or mists characterized in that it comprises:
corona-effect electrostatic precipitator assemblies comprising:
a plurality of tubular collecting electrodes (4) that periodically become electrical resistors positioned on a heat-resistant support (2) and are connected (13) to the ground or earth and a power supply enabling them to be heated individually or several at the same time,
a same plurality of emissive electrodes (5) as collecting electrodes (4) positioned in the center of each collecting electrode and fastened to an insulating and/or insulated support (3) for a DC supply and the earth for an AC supply.

2. Device for filtering and regeneration of claim 1 characterized in that the emissive electrodes are aligned in the direction of the flux to be treated (5).

3. Device for filtering and regeneration of claim 1 characterized in that the emissive electrodes described above are complemented by emissive electrodes perpendicular to the flux to be treated to form one or more beams (6) aligned in the axis of the collecting electrodes.

4. Device for filtering and regeneration of claim 1 characterized in that the supports of the collecting electrodes (2) are dielectric.

5. Device for filtering and regeneration of claim 1 characterized in that they comprise an envelope (1) or housing.

6. Device for filtering and regeneration of claim 1 characterized in that it comprises a second or several other regenerating electrostatic precipitators (15).

7. Device for filtering and regeneration of claim 1 characterized in that it comprises a sound attenuator or silencer (18).

8. Device for filtering and regeneration of claim 1 characterized in that it comprises a gas oxidation catalyst (19).

9. Device for filtering and regeneration of claim 1 characterized in that it comprises a system for draining (22) the zones receiving the solid or liquid particles.

10. Device for filtering and regeneration of claim 1 characterized in that it comprises a door, hatch or cover (24) allowing access, cleaning and removal of each of these components.

11. Device for filtering and regeneration of claim 1 characterized in that it comprises one or more inertial air pre-filter (20) that uses the Brown or shock effects, eliminator plates, mist eliminators, cyclones or any other system designed to improve the air, gases or the mists to be treated.

12. Device for filtering and regeneration of claim 1 characterized in that it comprises one or more fine filters (21) that use the Brown or shock effects, eliminator plates, mist eliminators, cyclones or any other system designed to increase and ensure the efficiency of the system.

13. Device for filtering and regeneration of claim 1 characterized in that it comprises an inlet (11) for the flux to be treated and an outlet (12) for the treated flux.

14. Use of a device for filtering and regeneration of claim 1 to filter exhaust gases of a heat engine, whether self-propelled or not.

15. Use of a device for filtering and regeneration of claim 1 to filter air, gases and/or mists by extraction from a zone loaded with particles.

16. Use of a device for filtering and regeneration of claim 1 to filter air, gases and/or mists by admission from a zone to be protected from such pollutants.

17. Use of a device for filtering and regeneration of claim 1 to filter air, gases and/or mists by regenerating a zone loaded with particles.
